(19) United States
(12) Patent Application Publication
(10) Pub. No.: US 2010/0273047 A1
(43) Pub. Date: Oct. 28, 2010

(54) SEALED BATTERY

(76) Inventors: Naoto Kunoike, Osaka (JP); Kenjin Masumoto, Hyogo (JP); Hiroya Tanaka, Osaka (JP); Tomomichi Ueda, Osaka (JP); Kyosuke Miyata, Osaka (JP)

Correspondence Address: MCDERMOTT WILL & EMERY LLP, 600 13TH STREET, NW, WASHINGTON, DC, 20005-3096, US

(21) Appl. No.: 12/809,340

(22) PCT Filed: Mar. 26, 2009
(86) PCT No.: PCT/JP2009/001354

§ 371 Date: Jun. 18, 2010

(30) Foreign Application Priority Data
Mar. 27, 2008 (JP) 2008-082802
Mar. 27, 2008 (JP) 2008-082803
Jul. 10, 2008 (JP) 2008-179842

(51) Int. Cl. H01M 2/02

(52) U.S. Cl. 429/181

(57) ABSTRACT

A gasket that provides sealing between an assembled sealing member and the opening of a battery case includes a high-strength layer inside thereof. The high-strength layer is formed by using a material having a higher strength than that of a gasket body. Examples of such a material include high-strength resins such as polyamide, polyimide and polyphenylene sulfide, and a ceramic. On the other hand, the gasket body is made of a material having a high level of sealing properties. With this configuration, even when extraneous metallic matter or the like is present in a sealed portion, it is possible to prevent both insulating properties and sealing properties of the sealed portion from being impaired.

### TECHNICAL FIELD

The present invention relates to a sealed battery, and more particularly to an improvement in a sealing structure that seals the opening of a battery case that houses a power generating element.

### BACKGROUND ART

Aqueous electrolyte secondary batteries, as typified by high capacity alkaline storage batteries, and non-aqueous electrolyte secondary batteries, as typified by lithium secondary batteries, are known as sealed batteries, in particular, as sealed secondary batteries used as a power source or the like for driving small portable devices.

Such sealed secondary batteries are made up of an electrode group including a positive electrode, a negative electrode and a separator, and an electrolyte that are housed in a metal battery case, and the opening of the battery case is sealed with a metal sealing plate. A resin gasket is interposed between the opening of the battery case and the sealing plate to provide sealing between the opening of the battery case and the sealing plate. In addition, a positive electrode lead and a negative electrode lead that are drawn from the electrode group are connected to the sealing plate and the battery case, respectively or vice versa, and the sealing plate and the battery case function as external terminals for positive and negative electrodes, respectively or vice versa. Accordingly, the gasket also functions as an insulating means for providing insulation between the battery case and the sealing plate.

As gaskets that can provide both insulating properties and sealing properties between the battery case and the sealing plate, for example, in the case of non-aqueous electrolyte secondary batteries, it has been proposed to use gaskets molded from an olefin-based polymer such as polypropylene, an fluorine-based polymer such as tetrafluoroethylene/perfluoro(alkyl vinyl ether) copolymer (PFA), a cellulose-based polymer, a polyimide, a polyamide, a block copolymer of propylene and ethylene, and the like (see Patent Documents 1 and 2).

Patent Document 1: Japanese Laid-Open Patent Publication No. 2001-202935

Patent Document 2: Japanese Laid-Open Patent Publication No. 2005-310569

### DISCLOSURE OF THE INVENTION

### Problem to be Solved by the Invention

It is indeed effective to use the above-proposed gaskets made of resin materials in order to maintain high levels of insulating properties and sealing properties between the battery case and the sealing plate. However, such gaskets made of resin materials mentioned above have a possibility that they could not maintain sufficient insulating properties and sealing properties if extraneous matter made of a metal or the like intrudes into the sealed portion.

To describe it in more detail, generally, sealed batteries have a configuration in which the opening of the battery case is clamped, with a gasket interposed between the opening of the battery case and the sealing plate, to fix the sealing plate. At this time, a portion thinner than the other portions (hereinafter referred to as a “highly pressurized portion”) is caused in the gasket, due to the gasket being partially and strongly compressed between the opening of the battery case and the sealing plate. If extraneous metallic matter such as a metal particle or a needle-shaped burr is present between the highly pressurized portion and the battery case or the sealing plate, in particular, the gasket is sheared through its entire thickness, the extraneous metallic matter penetrates that portion, and an electrical connection between the battery case and sealing plate is made via the extraneous metallic matter, which increases the possibility of occurrence of micro-short circuiting.

The present invention has been conceived in view of the problems encountered with conventional techniques described above, and it is an object of the present invention to provide a sealed battery in which even when electrically conductive extraneous matter is present between a gasket and the opening of a battery case or a sealing plate, the insulating properties and sealing properties provided by the gasket can be prevented from being impaired.

### Means for Solving the Problem

In order to achieve the above object, the present invention provides a sealed battery including:

an electrode group including a positive electrode, a negative electrode, and a separator;

an electrolyte;

a battery case with an opening housing said electrode group and said electrolyte and also serving as an external terminal for either one of the positive electrode and the negative electrode;

a sealing plate sealing the opening of said battery case and also serving as an external terminal for the other electrode; and

a gasket including a thermoplastic resin interposed between the opening of said battery case and said sealing plate,

wherein said gasket has a high-strength layer made of a material having greater strength than the other portions inside or on an outer face.

The present invention also provides a sealed battery including:

an electrode group including a positive electrode, a negative electrode, and a separator;

an electrolyte;

a battery case with an opening housing said electrode group and said electrolyte and also serving as an external terminal for either one of the positive electrode and the negative electrode;

a sealing plate sealing the opening of said battery case and also serving as an external terminal for the other electrode; and

a gasket including a thermoplastic resin interposed between the opening of said battery case and said sealing plate,

wherein said battery case has a coating layer made of a material having greater strength than said gasket on a surface of a portion in contact with said gasket.

According to a preferred embodiment of the sealed battery of the present invention, a portion of the gasket excluding the high-strength layer or the thermoplastic resin of the gasket includes polypropylene in an amount of 80 wt % or more.

According to another preferred embodiment of the sealed battery of the present invention, the high-strength layer or the coating layer includes a high-strength resin having a glass transition temperature or melting point of 300° C. or more.

Here, more preferably, the high-strength resin included in the high-strength layer and the coating layer is at least one selected from the group consisting of polyamide, polyimide, and polyphenylene sulfide.

According to another preferred embodiment of the sealed battery of the present invention, the high-strength layer or the coating layer includes a ceramic.

According to another preferred embodiment of the sealed battery of the present invention, the high-strength layer provided inside the gasket includes a metal.

Here, more preferably, the metal included in the high-strength layer is at least one selected from the group consisting of stainless steel, aluminum, and copper.

According to another preferred embodiment of the sealed battery of the present invention, in the gasket, the high-strength layer is formed on an outer face of a highly pressurized portion having the thinnest thickness due to the gasket being partially and strongly compressed between the battery case and the sealing plate. Alternatively, the coating layer is formed on a surface of the battery case in contact with the highly pressurized portion.

### EFFECT OF THE INVENTION

When the opening of a battery case is clamp-sealed with a gasket interposed between the opening of the battery case and a sealing plate, a highly pressurized portion is formed in which the gasket is partially strongly compressed between the opening of the battery case and the sealing plate and therefore has the smallest thickness. With the sealed battery of the present invention in which the gasket has a high-strength layer inside or on an outer face, even when electrically conductive extraneous matter is present between the highly pressurized portion and the battery case or the sealing plate, the presence of the high-strength layer can prevent the gasket from being sheared through its entire thickness. Consequently, it is possible to prevent the occurrence of micro-short circuiting caused by the electrically conductive extraneous matter penetrating the highly pressurized portion and making an electrical connection between the battery case and the sealing plate via the extraneous metallic matter.

In addition, with the sealed battery of the present invention in which a high-strength coating layer is provided on an inner face of the opening of the battery case, even when the gasket is sheared through its entire thickness in the above-described situation, the presence of the coating layer prevents the conductive extraneous matter from making an electrical connection between the battery case and the sealing plate. Accordingly, it is possible to prevent the occurrence of micro-short circuiting.

Consequently, it is possible to provide a sealed battery superior in electrical characteristics and safety.

### BRIEF DESCRIPTION OF THE DRAWINGS

FIG. 1 is a vertical cross-sectional view showing an schematic configuration of a sealed battery according to Embodiment 1 of the present invention.

FIG. 2 is a vertical cross-sectional view of part of a sealing structure of the sealed battery of FIG. 1, showing the details of the sealing structure.

FIG. 3 is a vertical cross-sectional view of part of a sealing structure of a sealed battery according to Embodiment 2 of the present invention, showing the details of the sealing structure.

FIG. 4 is a vertical cross-sectional view of part of a sealing structure of a sealed battery according to Embodiment 3 of the present invention, showing the details of the sealing structure.

FIG. 5 is a vertical cross-sectional view of part of a sealing structure according to a variation of the sealed battery according to Embodiment 3, showing the details of the sealing structure.

### BEST MODE FOR CARRYING OUT THE INVENTION

Hereinafter, embodiments of the present invention will be described in detail with reference to the drawings.

### Embodiment 1

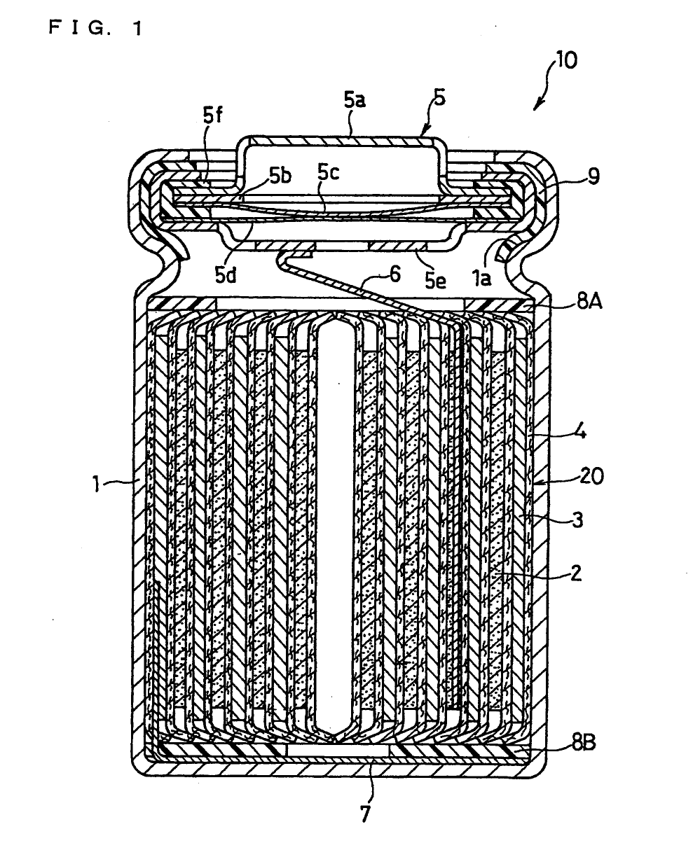

FIG. 1 shows a lithium secondary battery as a sealed battery according to Embodiment 1 of the present invention in a cross-sectional view.

A lithium secondary battery 10 shown in FIG. 1 is formed by housing an electrode group 20 in which a positive electrode 2, a negative electrode 3 and a separator 4 interposed therebetween are spirally wound in a bottomed metal cylindrical battery case 1 together with an electrolyte (not shown). The opening of the battery case 1 is sealed with an assembled sealing member 5 that includes a metal sealing plate 5a, whereby the electrode group 20 and the electrolyte are hermetically sealed inside the battery case 1. In the inside of the battery case 1, an upper-side insulating plate 8A and a lower-side insulating plate 8B are provided on the upper and lower sides of the electrode group 20, respectively.

The sealing plate 5a of the assembled sealing member 5 is electrically connected to the positive electrode 2 via a positive electrode lead 6, and functions as a positive electrode-side external terminal of the lithium secondary battery 10. The battery case 1 is electrically connected to the negative electrode 3 via a negative electrode lead 7, and functions as a negative electrode-side external terminal of the lithium secondary battery 10.

In addition, a resin gasket 9 is provided between the peripheral portion of the assembled sealing member 5 and the opening of the battery case 1. The gasket 9 provides sealing between the assembled sealing member 5 and the battery case 1, as well as insulation therebetween.

The assembled sealing member 5 is made up of the sealing plate 5a in the shape of a hat, a doughnut-shaped circular middle plate 5b, a diaphragm-shaped upper-side thin disc 5c, a lower-side thin disc 5d, an assembly substrate 5e that is in contact with the positive electrode lead 6, and an assembly gasket 5f. The sealing plate 5a and the middle plate 5b are in contact with each other at their peripheral portions. The middle plate 5b and the upper-side thin disc 5c are in contact with each other at their peripheral portions. The upper-side thin disc 5c and the lower-side thin disc 5d are in contact with each other at their center portions. The lower-side thin disc 5d and the assembly substrate 5e are in contact with each other at their peripheral portions. Consequently, the sealing plate 5a and the assembly substrate 5e are electrically connected to each other.

The assembly substrate 5e has a thin circular dish-shaped body and a cylinder portion rising from the peripheral portion of the body. The lower-side thin disc 5d is placed on the body of the assembly substrate 5e, the assembly gasket 5f is placed on the peripheral portion of the lower-side thin disc 5d, and, on the assembly gasket 5f, the upper-side thin disc 5c, the middle plate 5b and the sealing plate 5a are further placed. In this state, an upper end portion of the cylinder portion of the assembly substrate 5e is bent inward to clamp them, whereby the sealing plate 5a, the middle plate 5b, the upper-side thin disc 5c and the lower-side thin disc 5d are held in the assembly substrate 5e.

At this time, the peripheral portions of the sealing plate 5a, the middle thick plate 5b and the upper-side thin disc 5c are separated from the cylinder portion of the assembly substrate 5e by the assembly gasket 5f such that they do not come into contact with each other. The peripheral portion of the upper-side thin disc 5c is also separated from the peripheral portion of the lower-side thin disc 5d by the assembly gasket 5f such that they do not come into contact with each other.

Vent apertures (not shown) are formed in the sealing plate 5a, the middle plate 5b and the assembly substrate 5e. With such apertures, when the internal pressure of the battery case 1 accidentally increases to an excessively high level, the lower-side thin disc 5d ruptures, and the diaphragm-shaped upper-side thin disc 5c bulges upward and ruptures, whereby the current flowing between the sealing plate 5a and the assembly substrate 5e is cut off.

It should be understood that the present invention is not limited to the assembled sealing member 5 having the structure described above, and is also applicable to a sealed battery in which the opening of the battery case is sealed with a single-piece sealing plate. In this case as well, the same effects can be attained.

A protruding portion 1a that protrudes inward into the battery case 1 is provided near the opening of the battery case 1 so as to encircle the side wall of the battery case 1. The opening of the battery case 1 is clamp-sealed by bending the opening inward such that the peripheral portion of the assembled sealing member 5 is sandwiched between the opening and the protruding portion 1a and thereby the assembled sealing member 5 is fixed to the opening of the battery case 1.

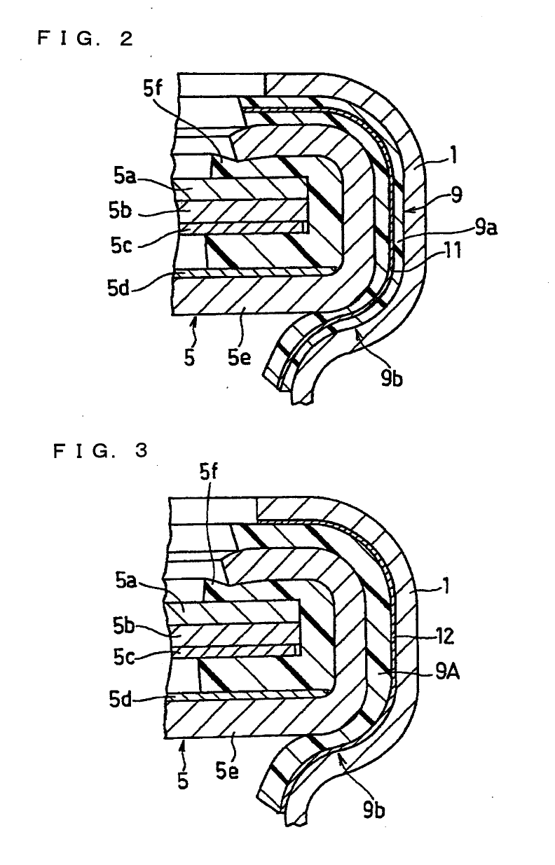

FIG. 2 is an enlarged view showing part of the sealing structure of the battery case 1. As shown in FIG. 2, the gasket 9 includes a high-strength layer 11 inside thereof.

Part (hereinafter referred to as a “gasket body”) 9a of the gasket 9 excluding the high-strength layer 11 can be made of a thermoplastic resin such as an olefin-based polymer, a fluorine-based polymer, a cellulose-based polymer, a polyimide or a polyamide in the case of a non-aqueous electrolyte secondary battery as typified by a lithium secondary battery. Among them, it is preferable to use an olefin-based polymer, in particular, polypropylene (PP) because it has resistance to organic solvents and low moisture permeability. The gasket body 9a preferably includes PP in an amount of 80% or more from the viewpoint of achieving good sealing properties provided by the gasket 9. In addition, it is preferable that the thermoplastic resin constituting the gasket body 9a has a melting point of 250° C. or less.

The high-strength layer 11 is a layer formed by using a material having a strength (at least one of tensile strength and hardness) greater than that of the material of the gasket body 9a. By providing such a high-strength layer 11 inside the gasket 9, even when electrically conductive extraneous matter is present between the gasket 9 and the opening of the battery case 1 or the assembled sealing member 5, it is possible to prevent the occurrence of micro-short circuiting caused by the extraneous matter penetrating the gasket 9, and making an electrical connection between the battery case 1 and the assembled sealing member 5. In particular, the possibility is high that a highly pressurized portion 9b where the thickness of the gasket 9 is smallest by being partially strongly compressed between the opening of the battery case 1 and the assembled sealing member 5 might be sheared by extraneous matter or the like. However, even in such a highly pressurized portion 9b, shearing of the gasket 9 is stopped by the high-strength layer 11, so it is possible to prevent the occurrence of micro-short circuiting caused by electrically conductive extraneous matter penetrating the gasket 9.

On the other hand, the gasket body 9a is made of a relatively soft resin as described above. Accordingly, even if electrically conductive extraneous matter exists, the gasket body 9a can cause the extraneous matter to be buried therein, whereby sealing properties provided by the gasket 9 are maintained.

Various materials can be conceived for the high-strength layer 11. For example, the high-strength layer 11 can be formed by using a high-strength resin material that has a strength greater than that of a resin used as a material for the gasket body 9a. Examples of such a resin include polyimide, polyamide and PPS (polyphenylene sulfide). It is preferable that the high-strength resin has a glass transition temperature or melting point of 300° C. or more.

The high-strength layer 11 may also be made of a metal. As a metal used for the high-strength layer 11, metal materials with superior malleability and ductility are preferable such as stainless steel (austenitic stainless steel in particular), aluminum (Al) and copper (Cu). The reason is that electrically conductive extraneous matter can be buried not only in the gasket body 9a but also in the high-strength layer 11 made of a metal with superior malleability and ductility.

In addition, the high-strength layer 11 may also be made of a ceramic. Because ceramic has high hardness, it can be preferably used as a material for the high-strength layer 11. Examples of such a ceramic include alumina, zirconia, silicon nitride, silicon carbide, and so on. However, the present invention is not limited thereto. The high-strength layer 11 can be formed from a sheet-like member or plate member made of such a ceramic material.

It is also possible to form the high-strength layer 11 by using a ceramic powder. In this case, a ceramic powder is mixed with an organic solvent to prepare a gel raw material (slurry), and a film-like member, which is used as a material for the high-strength layer 11, can be produced by using the raw material by a doctor blade method.

As described above, by providing, in the gasket 9, a high-strength layer 11 made of a material as described above, even when electrically conductive extraneous matter, such as metal particles having various shapes and needle-shaped burrs, is present between the gasket 9 and the opening of the battery case 1 or the assembled sealing member 5, it is possible to prevent the gasket 9 from being sheared through its entire thickness by the extraneous matter. In particular, even when sharing due to electrically conductive extraneous matter occurs in the highly pressurized portion 9b of the gasket 9 where the thickness is smallest by being partially strongly compressed between the protruding portion 1a of the battery case 1 and the assembled sealing member 5, the high-strength layer 11 stops the shearing from proceeding, so it is possible to prevent the electrically conductive extraneous matter from penetrating the gasket 9. Therefore, it is possible to suppress the occurrence of micro-short circuiting caused by the electrically conductive extraneous matter making an electrical connection between the battery case 1 and the assembled sealing member 5. Accordingly, even when electrically conductive extraneous matter has a size greater than the thickness of the highly pressurized portion 9b of the gasket 9, it is possible to suppress the occurrence of micro-short circuiting between the battery case 1 and the assembled sealing member 5.

The highly pressurized portion 9b of the gasket 9 becomes thinnest during the process in which the opening of the battery case 1 is clamp-sealed by using a clamping die or the like. After completion of the clamping process, when the clamped state by the claming die or the like is released, the thickness of the highly pressurized portion 9b of the gasket slightly increases back toward the original thickness.

For this reason, a situation can occur in which micro-short circuiting is not occurring after the completion of clamping process even though micro-short circuiting has occurred in the highly pressurized portion 9b during the clamping process. In such a situation, the battery may have a voltage failure due to the micro-short circuiting during the clamping process. According to the present invention, such micro-short circuiting during the clamping process is prevented, and therefore the occurrence of voltage failure in the battery can be suppressed as well.

From the viewpoint of productivity, it is preferable that the high-strength layer 11 is formed by using a resin as a material. The reason is that because the gasket body 9a is formed by molding a resin, by forming the high-strength layer 11 by molding a resin, the gasket 9 can be produced by, for example, integral molding, and improved productivity is obtained.

The positive electrode 2 can be made up of a positive electrode current collector and a positive electrode material mixture layer carried on the current collector. The positive electrode material mixture can include a positive electrode active material, and optionally a binder, a conductive material, and so on.

There is no particular limitation on the method for producing a positive electrode 2. For example, a positive electrode active material, a dispersing medium, and optionally a binder, a thickener, a conductive material and the like are mixed to obtain a positive electrode material mixture in the form of slurry. The obtained positive electrode material mixture is applied to a current collector and dried, and thereby a positive electrode 2 can be produced. The thus-obtained positive electrode 2 is molded by a roll into a sheet electrode.

The negative electrode 3 may be made only of a negative electrode material mixture, or may include a negative electrode current collector and a negative electrode material mixture layer carried on the current collector. The negative electrode material mixture can include a negative electrode active material, and optionally a binder, a conductive material, and so on.

There is also no particular limitation on the method for producing a negative electrode, and the negative electrode can be produced in the same manner as the above-described method for producing a positive electrode.

There is no particular limitation on the separator 4 disposed between the positive electrode 2 and the negative electrode 3. As the separator 4, for example, an organic microporous film and an inorganic microporous film can be used. The organic microporous film can be, for example, a porous sheet or non-woven fabric made of a polyolefin such as polyethylene (PE) or polypropylene (PP). The organic microporous film preferably has a thickness of 10 to 40 μm.

The inorganic microporous film contains, for example, an inorganic filler and an organic binder for binding the inorganic filler. The inorganic filler can be, for example, alumina or silica.

The inorganic microporous film only needs to be interposed between the positive electrode 2 and the negative electrode 3. As the method for interposing an inorganic microporous film between the positive electrode 2 and the negative electrode 3, for example, the following methods can be used: a method in which an inorganic microporous film is formed on the surface of the positive electrode 2 facing the negative electrode 3; a method in which an inorganic microporous film is formed on the surface of the negative electrode 3 facing the positive electrode 2; and a method in which an inorganic microporous film is formed on the surfaces of both the positive electrode 2 and the negative electrode 3. The inorganic microporous film preferably has a thickness of 1 to 20 μm.

The separator 4 may include both an inorganic microporous film and an organic microporous film. In the case of using both an inorganic microporous film and an organic microporous film, the thickness of the inorganic microporous film is preferably 1 to 10 μm, and the thickness of the organic microporous film is preferably 10 to 40 μm.

An example of the present invention will be described next, but it should be understood that the present invention is not limited to the following example.

### Example 1

A cylindrical lithium secondary battery as shown in FIG. 1 was produced in the following procedure.

First, a positive electrode 2 and a negative electrode 3 made of materials described in the above embodiment were spirally wound with a separator 4 interposed therebetween to form an electrode group 20. The electrode group 20 was housed in a bottomed cylindrical battery case 1 in which a lower-side insulating plate 8B was provided in the bottom portion, and thereafter, an upper-side insulating plate 8A was disposed on the electrode group 20. In this state, a protruding portion 1a was formed near the opening of the battery case 1 by using a roller so that the electrode group 20 was pressed from above due to the protruding portion 1a, and the electrode group 20 was held within the battery case 1.

Then, an assembled sealing member 5 was placed on the protruding portion 1a, and the battery case 1 was clamp-sealed by bending the opening of the battery case 1 inward. At this time, a gasket 9 was interposed between the opening of the battery case 1 and the assembled sealing member 5, the gasket 9 including a gasket body 9a molded from polypropylene (melting point: 170° C.). The gasket 9 had a thickness of 450 μm, and a high-strength layer 11 was formed in a substantially center position in the thickness direction by insert molding a 0.05 mm thick sheet-like member made of PPS (melting point: 300° C.). At this time, extraneous metallic matter serving as electrically conductive extraneous matter was disposed between the assembled sealing member 5 and the gasket 9.

In the manner described above, a cylindrical lithium secondary battery sample into which an electrolyte had not been injected was produced. In this example, as the extraneous metallic matter, five types of iron spheres having diameters of 150, 400, 420, 460 and 620 μm were used. One hundred samples were produced for each of the five types of extraneous metallic matter by disposing the extraneous metallic matter between the assembled sealing member 5 and the highly pressurized portion 9b of the gasket 9. In this manner, 500 samples in total were produced. The produced samples were then cut to measure the thickness of the gasket 9, and it was found that the thickness of the highly pressurized portion 9b was approximately 400 μm.

Immediately after the production of the samples, all of the samples were measured for inter-terminal resistance in an atmosphere of 25° C. Next, the same samples were left in an atmosphere of 45° C. for 24 hours, and thereafter the inter-terminal resistance was measured again. The results are shown in Table 1 below. In Table 1, a circle “◯” indicates that all of the 100 samples that contained extraneous metallic matter of corresponding size had an infinite inter-terminal resistance, and that there was no sample in which micro-short circuiting occurred. On the other hand, a cross “X” indicates the presence of a sample in which the terminals were electrically connected, or in other words, micro-short circuiting occurred, in the 100 samples that contained extraneous metallic matter of corresponding size.

### Comparative Example 1

A total of 500 cylindrical lithium secondary battery samples were produced in the same manner as in Example 1, except that a gasket including only a gasket body 9a made of the same material as that used in Example 1 without a high-strength layer 11 was used, and the samples were subjected to the same test as described in Example 1

TABLE 1

| Extraneous | | | | | |
|---|---|---|---|---|---|
| Metallic | | | | | |
| Matter | | Example 1 | | Comparative Example 1 | |
| | Particle | Immediately | After being | Immediately | After being |
| | Size | after battery | left at 45° C. | after battery | left at 45° C. |
| No. | (μm) | assembly | for 24 hours | assembly | for 24 hours |
| 1 | 620 | ◯ | ◯ | X | X |
| 2 | 460 | ◯ | ◯ | X | X |
| 3 | 420 | ◯ | ◯ | X | X |
| 4 | 400 | ◯ | ◯ | ◯ | ◯ |
| 5 | 150 | ◯ | ◯ | ◯ | ◯ |

As can be seen from Table 1, in Example 1 in which a gasket 9 provided with, inside thereof, a high-strength layer 11 made of a sheet-like PPS member was used, micro-short circuiting did not occur despite the fact that each of the five types of extraneous metallic matter Nos. 1 to 5 having particle sizes ranging from 150 to 620 μm was disposed between the gasket 9 and the assembled sealing member 5. This is presumably because due to the gasket 9 including the high-strength layer 11, shearing of the highly pressurized portion 9b of the gasket 9 caused by the extraneous metallic matter was stopped from proceeding by the high-strength layer 11, and therefore the penetration of the extraneous metallic matter through the gasket 9 was prevented.

On the other hand, in Comparative Example 1 in which the gasket was not provided with a high-strength layer 11, micro-short circuiting occurred in the samples that employed three types of extraneous metallic matter Nos. 1 to 3 having particle sizes of 620, 460 and 420 μm, respectively. This is presumably because the particle size of the extraneous metallic matter was larger than the thickness (approximately 400 μm) of the highly pressurized portion of the gasket, and therefore the extraneous metallic matter penetrated the gasket.

Even in Comparative Example 1, when extraneous metallic matter Nos. 4 and 5 having particle sizes of 400 and 150 μm were used, micro-short circuiting did not occur. This is presumably because the particle size of the extraneous metallic matter was not greater than the thickness of the highly pressurized portion of the gasket described above.

However, when the gasket of each sample of Example 1 and Comparative Example 1 that employed extraneous metallic matter No. 4 was observed by X-ray photography, shearing of the gasket 9 was stopped at the high-strength layer 11 in all of the samples of Example 1, whereas in Comparative Example 1, the presence of a sample in which the gasket was sheared through its entire thickness was confirmed. This is presumably because the extraneous metallic matter No. 4 had a particle size of 400 μm and the thickness of the highly pressurized portion of the gasket becomes thinnest during the process of clamp sealing, so the highly pressurized portion of the gasket was sheared through its entire thickness during that process. In other words, in the sample of Comparative Example 1 that employed extraneous metallic matter No. 4, it can be surmised that the battery case 1 and the assembled sealing member 5 were electrically connected to each other via the extraneous metallic matter during the process of clamp sealing, but after the completion of the clamp process, the micro-short circuit had disappeared. Accordingly, such a sample has a possibility that a voltage failure is occurring.

In the test results shown in Table 1, no difference was seen between immediately after the assembly thereof and after being left for 24 hours in an atmosphere of 45° C. However, it is believed that, by selecting a difficult-to-thermally-deform material such as PPS as a material for the high-strength layer 11 particularly when an easy-to-thermally-deform material such as polypropylene is used as a material for the gasket body, it is possible to suppress the degradation of insulating properties and sealing properties of the sealed portion in the event of an increase in the temperature of the lithium secondary battery.

In Example 1, PPS was used as a material for the high-strength layer 11, but it was confirmed that the same effects can be obtained even when a metal or ceramic was used as a material for the high-strength layer 11.

### Embodiment 2

Next, Embodiment 2 of the present invention will be described. The basic configuration of a sealed battery of Embodiment 2 is the same as that of Embodiment 1. Accordingly, in the following description, differences from Embodiment 1 will be mainly described.

FIG. 3 is an enlarged cross-sectional view showing part of a sealed battery according to Embodiment 2. As shown in FIG. 3, in the sealed battery of Embodiment 2, a gasket 9A does not include a high-strength layer 11 inside thereof. Instead, the battery case 1 has a coating layer 12 made of a material having a strength greater than that of the material of the gasket 9A on the inner face of the opening in contact with the gasket 9A. By providing such a coating layer 12 on the inner face of the opening of the battery case 1, when electrically conductive extraneous matter is attached to the inner face of the opening of the battery case 1, or when electrically conductive extraneous matter is present between the assembled sealing member 5 and the gasket 9, even if the extraneous matter penetrates the gasket 9A, it is possible to prevent the occurrence of micro-short circuiting caused by an electrical connection made between the battery case 1 and the assembled sealing member 5. Particularly when electrically conductive extraneous matter has penetrated the highly pressurized portion 9b where the thickness of the gasket 9A is smallest by being partially strongly compressed between the opening of the battery case 1 and the assembled sealing member 5, the occurrence of micro-short circuiting can be prevented effectively.

As a material for the gasket 9A, the same materials as used for the body 9a of the gasket 9 of Embodiment 1 can be used.

As a material for the coating layer 12, the same high-strength resins as used as materials for the high-strength layer 11 of Embodiment 1 can be used. In this case, the coating layer 12 can be formed by coating the inner face of the opening of the battery case 1 with such a resin material. Alternatively, it is also possible to form the coating layer 12 by forming a high-strength resin as mentioned above into a film, cutting the film into a specified shape, disposing the film on the inner face of the opening of the battery case 1, and heat-fusing the film.

In addition, as a material for the coating layer 12, it is also possible to use the same ceramic materials as used as materials for the high-strength layer 11 of Embodiment 1. In this case, the coating layer 12 can be formed by coating the inner face of the opening of the battery case 1 with, for example, a slurry of a ceramic powder used to form the high-strength layer 11 in Embodiment 1 and drying the slurry to solidify it.

Among the materials mentioned above, it is most preferable to use high-strength resins mentioned in Embodiment 1 as a material for the coating layer 12. The reason is that resins are highly elastic, and therefore provide better sealing properties.

An example of Embodiment 2 will be described next, but it should be understood that the present invention is not limited to the following example.

### Example 2

In Example 2, a coating layer 12 was formed by coating a portion extending from an upper portion of the protruding portion 1a of the battery case 1 to the opening edge of the battery case 1 with PPS. The coating layer 12 had a thickness of approximately 0.016 mm.

A gasket molded from polypropylene was used as a gasket 9A. The thickness was 450 μm. The opening was more strongly clamp-sealed such that the thickness of the highly pressurized portion 9b of the gasket 9A was reduced to approximately 150 μm.

Extraneous metallic matter serving as electrically conductive extraneous matter was disposed between the assembled sealing member 5 and the highly pressurized portion 9b of the gasket 9A. As the extraneous metallic matter, three types of iron spheres having diameters of 150, 175 and 190 μm were used. One hundred samples were produced for each of the three types of extraneous metallic matter by disposing the extraneous metallic matter between the assembled sealing member 5 and the gasket 9.

A total of 300 cylindrical lithium secondary battery samples into which an electrolyte had not been injected were produced in the same manner as in Example 1, except for the above. Then, the 300 samples were subjected to the same test as was performed for the samples of Example 1. The results are shown in Table 2 below.

### Comparative Example 2

Three hundred cylindrical lithium secondary battery samples were produced in the same manner as in Example 2, except that a coating layer 12 was not formed in the battery case 1. Then, the 300 samples were subjected to the same test as was performed for the samples of Example 1. The results are shown in Table 2 below.

TABLE 2

| Extraneous | | | | | |
|---|---|---|---|---|---|
| Metallic | | | | | |
| Matter | | Example 2 | | Comparative Example 2 | |
| | Particle | Immediately | After being | Immediately | After being |
| | Size | after battery | left at 45° C. | after battery | left at 45° C. |
| No. | (μm) | assembly | for 24 hours | assembly | for 24 hours |
| 11 | 190 | ◯ | ◯ | X | X |
| 12 | 175 | ◯ | ◯ | X | X |
| 13 | 150 | ◯ | ◯ | X | X |

As can be seen from Table 2, in Example 2 in which a coating layer 12 made of PPS was provided in the battery case 1, micro-short circuiting did not occur despite the fact that each of the three types of extraneous metallic matter Nos. 11 to 13 having particle sizes ranging from 150 to 190 μm was disposed between the gasket 9A and the assembled sealing member 5. This is presumably because the coating layer 12 was not sheared even when the gasket 9A was sheared through its entire thickness by the extraneous metallic matter, and therefore insulating properties were maintained.

On the other hand, in Comparative Example 1 in which the coating layer 12 was not provided, the presence of a sample in which micro-short circuiting occurred was confirmed when the extraneous metallic matter No. 11 to 13 were used. This is presumably because clamp sealing was performed with a strong force such that the thickness of the highly pressurized portion 9b of the gasket 9A was not greater than the particle size of each of the extraneous metallic matter No. 11 to 13, and therefore the extraneous metallic matter penetrated the highly pressurized portion 9b of the gasket.

In contrast, in Example 2, micro-short circuiting did not occur in the samples that employed extraneous metallic matter Nos. 11 and 12 having particle sizes of 175 and 190 μm despite the fact that clamp sealing was performed with a strong force such that the thickness of the highly pressurized portion 9b of the gasket 9A was reduced to approximately 150 μm. However, when all of the gaskets 9A used in Example 2 were observed by X-ray photography, the presence of a gasket 9A that had been sheared through its entire thickness was confirmed in the observed gaskets 9A. Accordingly, in this case, it was confirmed that the extraneous metallic matter had penetrated the gasket 9A but not penetrated the coating layer 12, and thus the coating layer 12 prevented micro-short circuiting from occurring.

In the test results shown in Table 2, no difference was seen between immediately after the assembly thereof and after being left for 24 hours in an atmosphere of 45° C. However, it is believed that, by selecting a difficult-to-thermally-deform material such as PPS as a material for the coating layer 12 particularly when an easy-to-thermally-deform material such as polypropylene is used as a material for the gasket body, it is possible to suppress the degradation of insulating properties and sealing properties of the sealed portion in the event of an increase in the temperature of the lithium secondary battery.

In Example 2, PPS was used as a material for the coating layer 12, but it was confirmed that the same effects can be obtained even when a ceramic was used as a material for the coating layer 12.

### Embodiment 3

Next, Embodiment 3 of the present invention will be described. The basic configuration of a sealed battery of Embodiment 3 is the same as that of Embodiment 1. Accordingly, in the following description, differences from Embodiment 1 will be mainly described.

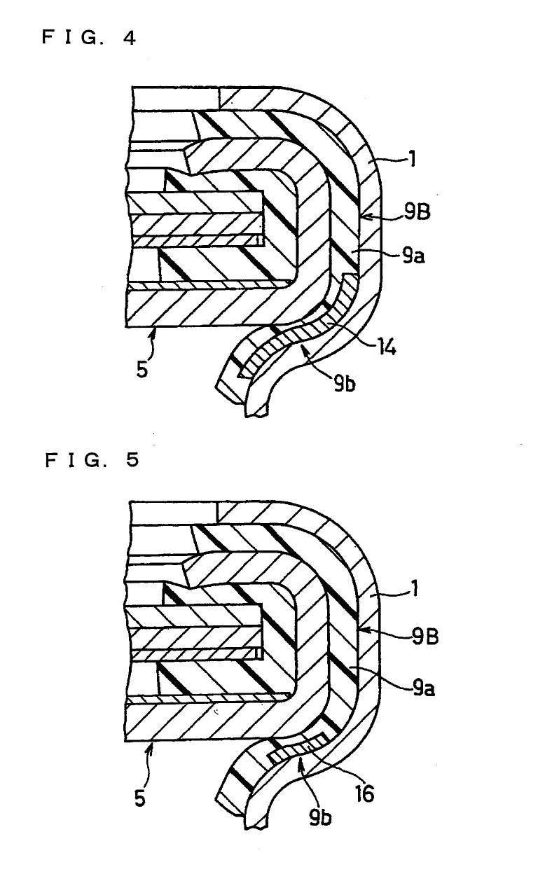

FIG. 4 is an enlarged cross-sectional view showing part of a sealed battery according to Embodiment 3. As shown in FIG. 4, in the sealed battery of Embodiment 3, a gasket 9B includes a high-strength layer 14 on its outer face rather than the inside. In other words, the gasket 9B is made up of a body 9a and the high-strength layer 14 provided on the outer face. As a material for the body 9a of the gasket 9B, the same materials used for the body 9a of the gasket 9 of Embodiment 1 can be used.

The high-strength layer 14 can be provided, as shown in FIG. 4, only on the outer face of the highly pressurized portion 9b in which the gasket 9B is partially strongly compressed between the assembled sealing member 5 and the opening of the battery case 1 and therefore has the smallest thickness. In FIG. 4, the high-strength layer 14 is provided on the outer face of the gasket 9B in contact with the inner face of the battery case 1, but the configuration is not limited thereto, and it is also possible to provide the high-strength layer 14 on the outer face of the gasket 9B in contact with the assembled sealing member 5. Alternatively, the high-strength layer 14 may be provided on both outer faces of the gasket 9B: an outer face of the gasket 9B in contact with the inner face of the battery case 1, and an outer face of the gasket 9B in contact with the assembled sealing member 5. It is also possible to provide the high-strength layer 14 in a portion in contact with the assembled sealing member 5 or the inner face of the opening of the battery case 1 such that the high-strength layer 14 extends the entire outer face of the gasket 9B. However, from the viewpoint of achieving good sealing properties of the gasket 9B, it is preferable to provide the high-strength layer 14 only on the outer face of the highly pressurized portion 9b of the gasket 9B.

By providing a high-strength layer 14 on the outer face of the gasket 9B as described above, when electrically conductive extraneous matter is attached to the inner face of the opening of the battery case 1, or when electrically conductive extraneous matter is present between the assembled sealing member 5 and the gasket 9, it is possible to prevent the occurrence of micro-short circuiting caused by the extraneous matter penetrating the gasket 9B and making an electrical connection between the battery case 1 and the assembled sealing member 5. In particular, it is possible to effectively prevent electrically conductive extraneous matter from penetrating the highly pressurized portion 9b of the gasket 9B.

As a material for the high-strength layer 14, the same resin materials as used as materials for the high-strength layer 11 of Embodiment 1 can be used.

As a material for the high-strength layer of Embodiment 3, the same ceramic materials as used as materials for the high-strength layer 11 of Embodiment 1 can be used.

FIG. 5 shows an example of a gasket 9B in which a ceramic is used as a material for the high-strength layer. In the sealing structure shown in FIG. 5, a high-strength layer 16 is made of an annular ceramic plate.

Among the materials mentioned above, it is most preferable to use resins as a material for the high-strength layer. The reason is that the gasket 9B can be produced by integrally molding the body 9a and the high-strength layer 14, and superior productivity can be achieved. In addition, resins are highly elastic and provide a high level of adhesion to the opening of the battery case 1 or the assembled sealing member 5, and therefore provide good sealing properties.

Examples of Embodiment 3 will be described next, but it should be understood that the present invention is not limited to the following examples.

### Example 3

In Example 3, as a gasket 9B, a gasket was employed in which a 0.05 mm thick sheet-like PPS member serving as a high-strength layer 14 was integrally molded on an outer face of a gasket body 9a containing polypropylene as the primary component. The high-strength layer 14 was formed on the outer face, in contact with the opening of the battery case 1, of the highly pressurized portion 9b of the gasket 9B. The opening of the battery case 1 was clamp-sealed with such strength that the gasket 9B having an original thickness of 450 μm was reduced to approximately 400 μm at the highly pressurized portion 9b.

Extraneous metallic matter serving as electrically conductive extraneous matter was disposed between the assembled sealing member 5 and the highly pressurized portion 9b of the gasket 9B. As the extraneous metallic matter, five types of iron spheres having diameters of 200, 300, 400, 500 and 600 μm were used. One hundred samples were produced for each of the five types of extraneous metallic matter by disposing the extraneous metallic matter between the assembled sealing member 5 and the gasket 9.

A total of 500 cylindrical lithium secondary battery samples into which an electrolyte had not been injected were produced in the same manner as in Example 1, except for the above. Then, the 500 samples were subjected to the same test as was performed for the samples of Example 1. The results are shown in Table 3 below.

### Example 4

In Example 4, as a gasket 9B, a gasket was employed in which a 0.05 mm thick annular ceramic plate (made of alumina) serving as a high-strength layer 16 was disposed on an outer face of a gasket body 9a including polypropylene as the primary component. The high-strength layer 16 was disposed on the outer face, in contact with the opening of the battery case 1, of the highly pressurized portion 9b of the gasket 9B. The opening of the battery case 1 was clamp-sealed with such strength that the gasket 9B having an original thickness of 450 μm was reduced to approximately 400 μm at the highly pressurized portion 9b.

In addition, in order to secure sealing properties between the ceramic high-strength layer 16 and the battery case 1, a butyl rubber-based sealant (a polybutadiene-based formulation available from Zeon Corporation, Japan) was applied to the surface of the high-strength layer 16.

Extraneous metallic matter serving as electrically conductive extraneous matter was disposed between the assembled sealing member 5 and the highly pressurized portion 9b of the gasket 9B. As the extraneous metallic matter, five types of iron spheres having diameters of 200, 300, 400, 500 and 600 μm were used. One hundred samples were produced for each of the five types of extraneous metallic matter by disposing the extraneous metallic matter between the assembled sealing member 5 and the gasket 9.

A total of 500 cylindrical lithium secondary battery samples into which an electrolyte had not been injected were produced in the same manner as in Example 1, except for the above. Then, the 500 samples were subjected to the same test as was performed for the samples of Example 1. The results are shown in Table 3 below.

### Comparative Example 3

Five hundred cylindrical lithium secondary battery samples were produced in the same manner as in Examples 3 and 4, except that a gasket made of the same material as the gasket body 9a used in Examples 3 and 4 without a high-strength layer was used. Then, the 500 samples were subjected to the same test as was performed for the samples of Examples 3 and 4. The results are shown in Table 3 below.

TABLE 3

| | | | | | | Comparative Example 3 | |
|---|---|---|---|---|---|---|---|
| Extraneous | | Example 3 | | Example 4 | | | After |
| Metallic | | | After | | After | | being |
| Matter | | | being | | being | Immediately | left at |
| | Particle | Immediately | left at | Immediately | left at | after | 45° C. for |
| | Size | after battery | 45° C. for | after battery | 45° C. for | battery | 24 |
| No. | (μm) | assembly | 24 hours | assembly | 24 hours | assembly | hours |
| 21 | 600 | ◯ | ◯ | ◯ | ◯ | X | X |
| 22 | 500 | ◯ | ◯ | ◯ | ◯ | X | X |
| 23 | 400 | ◯ | ◯ | ◯ | ◯ | ◯ | ◯ |
| 24 | 300 | ◯ | ◯ | ◯ | ◯ | ◯ | ◯ |
| 25 | 200 | ◯ | ◯ | ◯ | ◯ | ◯ | ◯ |

As can be seen from Table 3, in Examples 3 and 4 in which a high-strength layer 14 or 16 was provided on the outer face of the gasket 9B, micro-short circuiting did not occur despite the fact that each of the five types of extraneous metallic matter Nos. 21 to 25 having particle sizes ranging from 200 to 600 μm was disposed between the gasket 9B and the assembled sealing member 5. This is presumably because due to the high-strength layer 14 or 16 provided on the outer face of the gasket 9B, shearing of the gasket 9 caused by the extraneous metallic matter was stopped from proceeding by the high-strength layer 14 or 16, and therefore the penetration of the extraneous metallic matter through the gasket 9B was prevented.

On the other hand, in Comparative Example 3 in which the high-strength layers 14 and 16 were not provided in the gasket 9B, the presence of a sample in which micro-short circuiting occurred was confirmed when two types of extraneous metallic matter Nos. 21 and 22 having particle sizes of 500 and 600 μm were used. This is presumably because the particle size of the extraneous metallic matter was larger than the thickness (approximately 400 μm) of the highly pressurized portion 9b of the gasket 9B, and therefore the extraneous metallic matter penetrated the gasket 9B.

Even in Comparative Example 1, when extraneous metallic matter Nos. 23 to 25 having particle sizes ranging from 200 to 400 μm were used, micro-short circuiting did not occur. This is presumably because the particle size of the extraneous metallic matter was not greater than the thickness of the highly pressurized portion of the gasket described above.

However, when the gasket of each sample of Examples 3 and 4 and Comparative Example 1 that employed extraneous metallic matter No. 23 was observed by X-ray photography, in Examples 3 and 4, shearing of the gasket 9 was stopped at the high-strength layer 14 or 16, whereas in Comparative Example 3, the presence of a sample in which the gasket was sheared through its entire thickness was confirmed. This is presumably because the extraneous metallic matter No. 23 had a particle size of 400 μm and the thickness of the highly pressurized portion 9b of the gasket becomes thinnest during the process of clamp sealing, so the highly pressurized portion 9b of the gasket was sheared through its entire thickness. In other words, in the sample of Comparative Example 3 that employed extraneous metallic matter No. 23, it can be surmised that the battery case 1 and the assembled sealing member 5 were electrically connected to each other via the extraneous metallic matter during the process of clamp sealing, but after the completion of the clamp process, the micro-short circuit had disappeared. Accordingly, such a sample has a possibility that a voltage failure is occurring.

In the test results shown in Table 3, no difference was seen between immediately after the assembly thereof and after being left for 24 hours in an atmosphere of 45° C. However, it is believed that, by selecting a difficult-to-thermally-deform material such as PPS as a material for the high-strength layer 14 or 16 particularly when an easy-to-thermally-deform material such as polypropylene is used as a material for the gasket body, it is possible to suppress the degradation of insulating properties and sealing properties of the sealed portion in the event of an increase in the temperature of the lithium secondary battery.

As described above, in Examples 1 to 4, cylindrical lithium secondary batteries were tested. However, it is needless to say that the same effects can be achieved even when prismatic sealed batteries are used as long as the batteries can be assembled through clamp sealing. In addition, the present invention is not limited to lithium secondary batteries, and the same effects can be obtained even when alkaline storage batteries are used.

### INDUSTRIAL APPLICABILITY

With the sealed battery of the present invention, even when electrically conductive extraneous matter is caught in the highly pressurized portion in which the resin gasket is partially strongly compressed during clamp sealing and therefore the thickness becomes smallest, it is possible to suppress the occurrence of micro-short circuiting. Because the safety of the sealed battery is improved, the present invention is useful for application as a portable power source for which even higher energy density is required.

1. A sealed battery comprising:
an electrode group including a positive electrode, a negative electrode, and a separator;
an electrolyte;
a battery case with an opening housing said electrode group and said electrolyte and also serving as an external terminal for either one of the positive electrode and the negative electrode;
a sealing plate sealing the opening of said battery case and also serving as an external terminal for the other electrode; and
a gasket including a thermoplastic resin interposed between the opening of said battery case and said sealing plate,
wherein said gasket has a high-strength layer made of a material having greater strength than the other portions inside or on an outer face, or said battery case has a coating layer made of a material having greater strength than said gasket on a surface of a portion in contact with said gasket.

2. The sealed battery in accordance with claim 1, wherein said thermoplastic resin includes polypropylene in an amount of 80 wt % or more.

3. The sealed battery in accordance with claim 1 wherein said high-strength layer or said coating layer includes a high-strength resin having a glass transition temperature or melting point of 300° C. or more.

4. The sealed battery in accordance with claim 3, wherein the high-strength resin included in said high-strength layer and said coating layer is at least one selected from the group consisting of polyamide, polyimide, and polyphenylene sulfide.

5. The sealed battery in accordance with claim 1, wherein said high-strength layer or said coating layer includes a ceramic.

6. The sealed battery in accordance with claim 1, wherein said high-strength layer provided inside said gasket includes a metal.

7. The sealed battery in accordance with claim 6, wherein the metal included in said high-strength layer is at least one selected from the group consisting of stainless steel, aluminum, and copper.

8. The sealed battery in accordance with claim 1, wherein in said gasket, said high-strength layer is formed on an outer face of a highly pressurized portion having the thinnest thickness due to said gasket being partially and strongly compressed between said battery case and said sealing plate.

9. The sealed battery in accordance with claim 1, wherein in said battery case, said coating layer is formed on a surface of a portion in contact with a highly pressurized portion of said gasket, said highly pressurized portion having the thinnest thickness due to said gasket being partially and strongly compressed between said battery case and said sealing plate.
